(19) United States
(12) Patent Application Publication
(10) Pub. No.: US 2004/0171710 A1
(43) Pub. Date: Sep. 2, 2004

(54) Foam system for jacking concrete slabs

(75) Inventors: Gary Maechtle, Tobaccoville, NC (US); Richard T. Stoehr, King, NC (US)

Correspondence Address: ADAM EVANS, P.A., (formerly Adams, Schwartz & Evans, P.A.), 2180 TWO WACHOVIA CENTER, CHARLOTTE, NC, 28282, US

(73) Assignee: BARNHARDT MANUFACTURING COMPANY

(21) Appl. No.: 10/737,228

(22) Filed: Dec. 16, 2003

Related U.S. Application Data
(60) Provisional application No. 60/437,838, filed on Jan. 3, 2003.

(51) Int. Cl. C08J 9/00; C08G 18/00

(52) U.S. Cl. 521/155

(57) ABSTRACT

A closed cell, HFC-245fa blown rigid polyurethane foam system designed for lifting concrete composite slabs back to their original position in either wet or dry site conditions. The blown rigid polyurethane foam includes an isocyanate (A) component and a polyol (B) component. The isocyanate and polyol are fed to a metering system and separately pumped to a two-component mix head. An exit nozzle of the mix head is extended into an injection hole formed in a slab and injected into a void beneath the slab to be lifted causing a reaction. The reaction creates a closed-cell foam that lifts and supports the concrete slab.

This application claims the benefit of Provisional Application No. 60/437,838, filed on Jan. 3, 2003.

### TECHNICAL FIELD AND BACKGROUND OF THE INVENTION

This invention relates to a closed cell, HFC-245fa blown rigid polyurethane foam system designed for lifting (jacking) concrete composite slabs back to their original position in either wet or dry site conditions. This foam system can also be used for deep injection to overcome the compaction of soil and any other applications where damp conditions could affect the quality of the foam. Rigid polyurethane foam systems have been used for some time to raise concrete slabs, whether they are road beds, building floors, dock aprons, backyard patios or any such structure back to their original position after settling occurred due to erosion, shifting, settling, compaction, or any such movement of the base below the slabs. In many such instances water has infiltrated the areas beneath the slabs and causes problems in the application as a jacking material due to the effect the water has on the reaction chemistry of the polyurethane foam system. The reaction of isocyanates (one of the major reactive components of a urethane foam system) and water yields a substituted urea and CO₂. This reaction produces a source of gas for blowing the foam and must be controlled to obtain the desired density of the foam. Incorporation of uncontrolled amounts of the substituted urea in the foam polymer can have a severe deleterious affect on the physical properties of the foam. The urethane foam must remain essentially in a closed cell state during and after the foaming (lifting) operation in order to effectively do the intended job. Any cell opening during the expansion of the foam causes off gassing of the expansion gases and greatly reduces the lifting capacity of the foam. Any open cells in the cured-in-place foam allows for moisture penetration or storage in the matrix of the foam, which after time will have a severe deleterious affect on the structural integrity of that foam.

Prior art systems include rigid polyurethane foams with moisture repelling auxiliary blowing agents such as CFC-11, CFC-12, HCFC-141b, HCFC-22, methylene chloride and other related compounds. Such compounds are relatively insoluble in water. When incorporated into a polyurethane foam system as a blowing agent, these agents help to isolate the foaming mass from the water or moisture in the vicinity and facilitate the formation of a quality closed-cell foam product. This technology has worked well enough in wet environments to allow the pouring and forming of closed-cell foam bridge pads on open water. Such foams, utilizing the aforementioned blowing agents to achieve their desired density, can also be formulated with specific catalysts to minimize the reaction of the isocyanates with any surrounding water, thus decreasing any detrimental effect the uncontrolled moisture levels might have on the resulting foams.

The prior art also includes water (CO₂) blown closed-cell polyurethane foams that perform well at lifting and foaming in relatively dry environments. In the use of these types of materials a controlled amount of water is incorporated into the formulation to achieve a certain set of finished foam properties. The environments in which the liquid components of the polyurethane foam system are injected and foamed are closely monitored and excessive moisture is minimized or eliminated. Such foams when reacted in the presence of uncontrolled moisture suffer resulting detrimental affects on the physical properties of the finished foams such as low in-place density, reduced compressive strengths and coarse cell structure. They may, however, still maintain the ability to do a considerable amount of lifting since their closed-cell nature may be maintained.

Prior art may also include water (CO₂) blown open-celled polyurethane foams made from liquid components that are relatively hydrophobic in nature. These foams tend to be very fine-celled when foamed in the presence of water, however their resulting densities are much lower than formulated and the foams are of an open-celled nature such that they have very little lifting power and a great propensity for holding water within their foam matrix. This held water has severe repercussions on the long-term structural integrity of the resulting foams especially through several freeze and thaw cycles.

### SUMMARY OF THE INVENTION

Therefore, it is an object of the invention to provide a closed cell foam system for use in lifting concrete slabs.

It is another object of the invention to provide a closed cell foam system that utilizes a hydrophobic liquid component that when mixed and foamed in water results in a closed-cell foaming mass with relatively as much lifting power as that achieved when foaming in dry conditions.

These and other objects of the present invention are achieved in the preferred embodiments disclosed below by providing a closed-cell polyurethane foam, including hydrophobic liquid components for producing a foaming mass mixed in the presence of water, the hydrophobic liquid components include an isocyanate (A) component and a polyol (B) component for mixing together to cause a reaction whereby the reaction forms a foaming mass.

According to another preferred embodiment of the invention, the isocyanate (A) component contains additives selected from the group consisting of halogenated esters, halogenated phosphate esters, plasticizers, and standard additives used in a urethane foam for altering finished foam properties.

According to another preferred embodiment of the invention, the polyol (B) component comprises a polyether and a polyester polyol with a functionality of about 1.5 to about 6.0 and a molecular weight of about 250 to about 1250.

According to another preferred embodiment of the invention, the polyol (B) component comprises a polyether polyol with a functionality of about 2.0 to about 6.0 and a molecular weight of about 400 to about 1000.

According to another preferred embodiment of the invention, the polyol (B) component comprises a polyester polyol with a functionality of about 1.5 to about 3.0 and a molecular weight of about 250 to about 1250.

According to another preferred embodiment of the invention, the polyol (B) component comprises a modifier selected from the group consisting of glycerin, short chain glycols, chlorinated phosphate, benzuate, dibasic esters, water, silicone surfactants, acidic buffering agents, teritiary amine, and metallic catalysts for the promotion of alcohol hydrogen.

According to another preferred embodiment of the invention, the method of lifting and supporting a slab, includes the steps of (a) feeding an isocyanate (A) component and a polyol (B) component into a metering unit; (b) separately pumping the isocyanate (A) component and the polyol (B) component to a two component mixing head; (c) forming an injection hole in a slab to be lifted; (d) extending an exit nozzle of the mixing head into the injection hole; and (e) injecting a metered and mixed amount of isocyanate (A) component and polyol (B) component into a void beneath the slab causing a reaction between the isocyanate (A) component and the polyol (B) component whereby the reaction forms a foaming mass which lifts and supports the slab.

### BRIEF DESCRIPTION OF THE DRAWINGS

Some of the objects of the invention have been set forth above. Other objects and advantages of the invention will appear as the invention proceeds when taken in conjunction with the following drawing, in which:

FIG. 1 is a schematic diagram of a system according to the present invention.

FIG. 2 shows the sunken concrete slab before the foam is injected into the void beneath the slab.

FIG. 3 shows the sunken slab after the foam has raised the slab level with the corresponding slab.

### DESCRIPTION OF THE PREFERRED EMBODIMENT AND BEST MODE

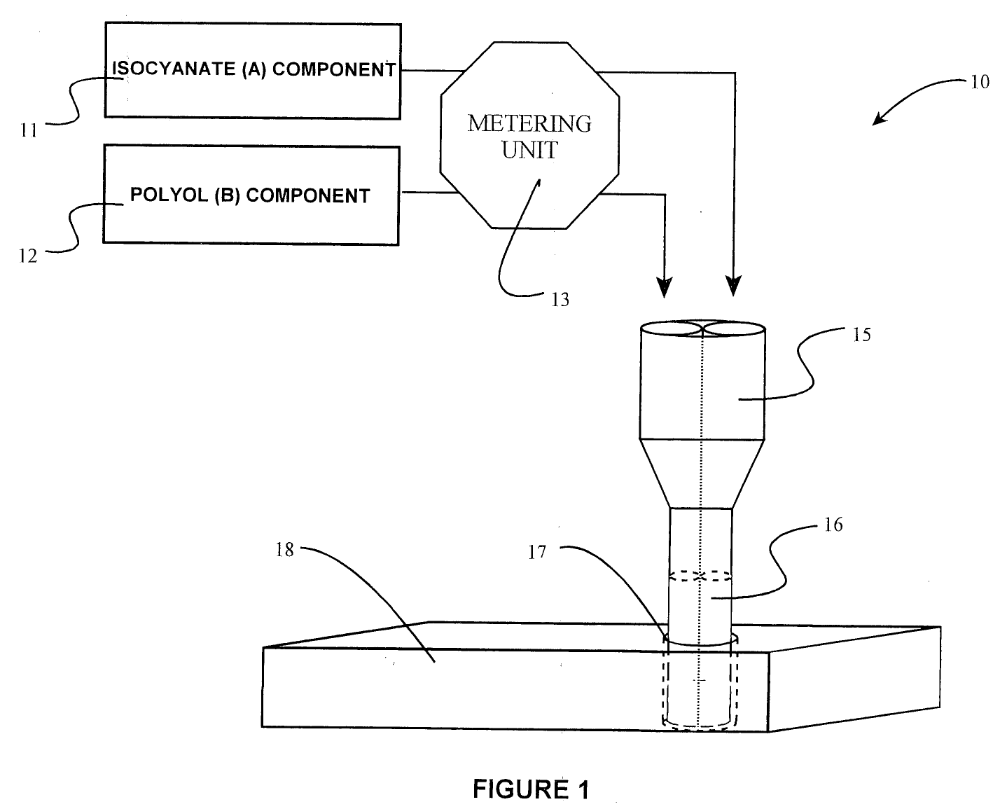

Referring now specifically to the drawings, a foam system according to the present invention is illustrated in FIG. 1-3 and shown generally at reference numeral 10.

The present invention embodies a HFC-245fa blown, closed-cell rigid polyurethane foam system with relatively hydrophobic liquid components that when mixed and foamed in the presence of water results in a closed-cell foaming mass with relatively as much lifting power as that achieved when foaming in dry conditions. The resulting foam density is much less effected by the presence of uncontrolled, environmentally induced water than present open or closed cell water (CO₂) blown polyurethane rigid foams. The resulting foams in wet conditions also maintain a higher degree of their compressive strength relative to their dry environment foamed counterparts.

The mixed, foaming liquid or semi-liquid components of this system can be processed with existing conventional urethane system dispensing equipment. The liquid components of the system are sufficiently low enough in viscosity to be adequately mixed through impingement at pressures less than 1200 psi.

As shown in the drawing, the isocyanate (A) component 11 is MDI or PMDI and can contain such additives as generally used in urethane system formulations to alter finished foam properties such as halogenated esters, halogenated phosphate esters, conventional plasticizers or other standard additives used in urethane foam system formulating.

The polyol (B) component 12 is comprised of polyether polyols with a functionality of 2.0 to 6.0 and molecular weights from 400 to 1000 and preferably a starter material having hydrophic character, and/or polyester polyols with a functionality of 1.5 to 3.0 and molecular weights from 250 to 1250 and preferably (non essential). Furthermore the polyol (B) component 12 includes modifiers such as glycerin and/or short chain glycols (non-essential), chlorinated phosphate and/or benzoate and/or dibasic esters, water, silicone surfactants of a hydrophobic nature, an acidic buffering agent (non essential), tertiary amine and/or metallic catalyst that are partial to the alcohol hydrogen reaction with isocyanates, and 1,1,1,3,3,-pentafluoropropane (HFC-245fa).

Referring specifically to FIG. 1, the isocyanate (A) component 11 and the polyol (B) component 12 are fed to a metering unit 13 and separately pumped to a two-component mix head 15. An injection hole 17 is formed in the portion of the concrete slab 18 to be lifted, and the exit nozzle 16 of the mix head 15 is extended into the injection hole.

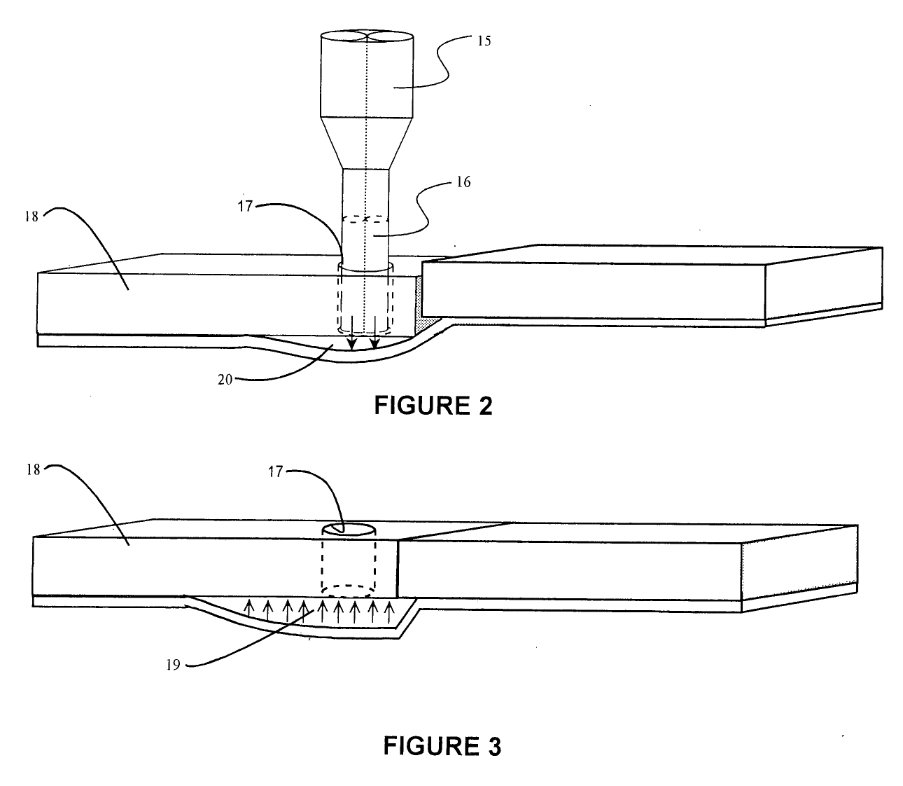

Referring now to FIGS. 2 and 3, the metered constituents are injected into the void 20 beneath the slab 18 to be lifted. The reaction between the isocyanate (A) component 11 and polyol (B) component 12 creates a closed-cell foam 19 that lifts the concrete slab 18, as shown.

TABLE A
One preferred embodiment of the system is set out below:

| | | |
|---|---|---|
| 50-100 | parts | Jeffol AD-395 |
| 50-100 | parts | 700 mw propoxylated glycerin |
| 6.0-10.0 | parts | Glycerin |
| 10-15 | parts | Dibasic esters (DuPont DBE) |
| 1.0-2.0 | parts | Niax ® L-5340 |
| 0-0.25 | parts | TEDA |
| 0-0.5 | parts | Organic tin |
| 0.25-2.0 | parts | Organo sodium |
| 1.0-2.0 | parts | Water |
| 0.1-0.25 | parts | 2-ethyl hexanoic acid |
| 2.0-6.0 | parts | HFC-245fa |

A foam system for jacking concrete slabs described above. Various details of the invention may be changed without departing from its scope. Furthermore, the foregoing description of the preferred embodiments of the invention and the best mode for practicing the invention are provided for the purpose of illustration only and not for the purpose of limitation.

We claim:

1. A closed-cell, HFC-245fa blown rigid polyurethane foam with hydrophobic liquid components for being mixed and foamed in the presence of water resulting in a closed-cell foaming mass with a lifting power proportional to the lifting power achieved in a dry condition, comprising:
(a) an isocyanate (A) component for altering finished foam properties;
(b) a polyol (B) component, comprising:
(i) a modifier for the promotion of alcohol hydrogen; and
(ii) a polyether polyol with a functionality of about 2.0 to about 6.0 and a molecular weight of about 400 to about 1000.

2. The closed-cell, HFC-245fa blown rigid polyurethane foam according to claim 1, wherein the isocyanate (A) component contains additives selected from the group consisting of halogenated esters, halogenated phosphate esters, and plasticizers for altering finished foam properties.

3. The closed-cell, HFC-245fa blown rigid polyurethane foam according to claim 1, wherein the modifier is selected from the group consisting of glycerin, short chain glycols, chlorinated phosphate, benzuate, dibasic esters, water, silicone surfactants, acidic buffering agents, teritiary amine, and metallic catalysts.

4. The closed-cell, HFC-245fa blown rigid polyurethane foam according to claim 1, wherein the polyol (B) component further comprises a polyester polyol.

5. A closed-cell, HFC-245fa blown rigid polyurethane foam with hydrophobic liquid components for being mixed and foamed in the presence of water resulting in a closed-cell foaming mass with a lifting power proportional to the lifting power achieved in a dry condition, comprising:
(a) an isocyanate (A) component for altering finished foam properties;
(b) a polyol (B) component, comprising:
(i) a modifier for the promotion of alcohol hydrogen; and
(ii) a polyester polyol with a functionality of about 1.5 to about 3.0 and a molecular weight of about 250 to about 1250.

6. The closed-cell, HFC-245fa blown rigid polyurethane foam according to claim 1, wherein the isocyanate (A) component contains additives selected from the group consisting of halogenated esters, halogenated phosphate esters, and plasticizers for altering finished foam properties.

7. The closed-cell, HFC-245fa blown rigid polyurethane foam according to claim 1, wherein the modifier is selected from the group consisting of glycerin, short chain glycols, chlorinated phosphate, benzuate, dibasic esters, water, silicone surfactants, acidic buffering agents, teritiary amine, and metallic catalysts.

8. The closed-cell, HFC-245fa blown rigid polyurethane foam according to claim 1, wherein the polyol (B) component further comprises a polyether polyol.

9. A method for injecting a closed-cell, HFC-245fa blown rigid polyurethane foam into a void beneath a floor or slab, comprising the steps of:
(a) forming an injection hole in a floor or slab to be lifted;
(b) feeding an isocyanate (A) component and a polyol (B) component separately into a metering unit whereby the isocyanate (A) component and the polyol (B) component remain in an unmixed state;
(c) separately pumping the isocyanate (A) component and the polyol (B) component to a two component mixing head;
(d) extending an exit nozzle of the mixing head into the injection hole; and
(e) injecting a metered amount of isocyanate (A) component and polyol (B) component into a void beneath the slab causing a reaction between the isocyanate (A) component and the polyol (B) component whereby the reaction forms a foaming mass which lifts and supports the slab.
